(19) United States
(12) Patent Application Publication
(10) Pub. No.: US 2020/0156083 A1
(43) Pub. Date: May 21, 2020

(54) TREATMENT OF TAILINGS WITH FLUE-GAS DESULFURIZATION SOLIDS

(71) Applicant: SYNCRUDE CANADA LTD. in trust for the owners of the Syncrude Project as such owners exist now and in, Fort McMurray (CA)

(72) Inventors: RANDY MIKULA, Edmonton (CA); JONATHAN SPENCE, Edmonton (CA); WARREN ZUBOT, Edmonton (CA); BARRY BARA, Edmonton (CA); JAMES LORENTZ, Fort McMurray (CA)

(21) Appl. No.: 16/687,425

(22) Filed: Nov. 18, 2019

Related U.S. Application Data
(60) Provisional application No. 62/769,406, filed on Nov. 19, 2018.

(51) Int. Cl. B03B 1/04; C10G 1/04; B03B 9/02; C10G 33/04

(52) U.S. Cl. CPC B03B 1/04; C10G 1/047; B03B 9/02; C10G 2300/207; C10G 2300/405; C10G 2300/80; C10G 33/04

(57) ABSTRACT

A process for improving the dewatering characteristic of tailings is provided comprising adding flue-gas desulfurization (FGD) solids, produced when using calcium oxide to remove sulfur dioxide from flue gas or emissions, to the tailings.

### FIELD OF THE INVENTION

The present invention relates to a process for treating tailings that uses flue-gas desulfurization (FGD) solids as an additive. The FGD solids used are those produced when using calcium oxide to remove sulfur dioxide from flue gases and emissions.

### BACKGROUND OF THE INVENTION

Oil sand generally comprises water-wet sand grains held together by a matrix of viscous heavy oil or bitumen. Bitumen is a complex and viscous mixture of large or heavy hydrocarbon molecules that contain a significant amount of sulfur, nitrogen and oxygen. The key characteristic of Alberta oil sand that makes bitumen economically recoverable is that the sand grains are hydrophilic and encapsulated by a water film that is then covered by bitumen. The water film prevents the bitumen from being in direct contact with the sand and, thus, by slurrying mined oil sand with heated water, the bitumen is allowed to be liberated from the sand grains and move to the aqueous phase. A primary separation vessel (PSV) is normally used for bitumen separation from the solids to produce bitumen froth.

The PSV product, or primary bitumen froth, is a mixture of bitumen, water, and solids. The target composition of this froth product is ≥60 wt % in bitumen, ≤30 wt % in water, and ≤10 wt % in solids. To enable downstream upgrading, the PSV froth must first be cleaned in a froth treatment process to reduce the water and solids contents to desirable levels. Currently, two different types of froth treatment processes are commercially employed; naphthenic froth treatment, which uses a naphtha diluent typically obtained from the downstream coking of bitumen, and paraffinic froth treatment, which uses a paraffinic diluent composed of a mixture of hexanes and pentanes. Froth treatment involves the removal of water and solids still present in the deaerated bitumen froth to produce a bitumen product for upgrading.

At each stage of extraction of bitumen from oil sand and bitumen froth treatment, large volumes of tailings composed of varying degrees of sand, fine silts, clays, residual bitumen and water are produced. Many of the tailings streams produced are comprised primarily of “fines”, i.e., mineral fractions with a particle diameter less than 44 microns. A “fine tailings” suspension is typically 85% water and 15% fine particles by mass. Dewatering of fine tailings occurs very slowly. When first discharged in ponds, any high-density solids will sink to the bottom and separate from the very low-density material, which is generally referred to as “thin fine tailings”. After a few years when the thin fine tailings have reached a solids content of about 30-35%, they are referred to as “fluid fine tailings” (FFT) or “mature fine tailings” (MFT), which tailings behave as a fluid-like colloidal material. The fact that fluid fine tailings behave as a fluid and have very slow consolidation rates significantly limits options to reclaim tailings ponds.

It is particularly challenging to dewater or solidify fluid fine tailings (FFT) to the point where these tailings can support standard reclamation equipment and techniques. Recently, the present Applicant developed a process for dewatering oil sands tailings, including FFT, by treating tailings with a coagulant and a flocculant prior to dewatering by centrifugation (see Canadian Patent No. 2,787,607). The centrifugation process is particularly useful with, but not limited to, fluid fine tailings (FFT), and produces a centrifuge cake for further reclamation. In the Applicant's operation, the coagulant used is gypsum (calcium sulfate dihydrate). It was found that gypsum addition helped to increase throughput by creating a stronger cake, allowing for more aggressive removal rates and therefore higher tonnes per hour per machine.

Another process developed by the present Applicant to address the issue of fluid fine tailings (FFT) is the composite tailings (CT) process, which involves combining a process aid and sand with FFT. CT technology causes the FFT to consolidate faster and produce non-segregating tailings (also known as NST). Early work to develop the CT process identified a number of suitable process aids including lime, polymers, acid, carbon dioxide, gypsum, alum, and combinations thereof (see Matthews, J. G, Shaw, W. H., Mackinnon, M. D., and Cuddy, R. G. (2002). Development of composite tailings technology at Syncrude, International Journal of Surface Mining, Reclamation and Environment, 16(1), 24-39). For the Applicant's commercial CT process, gypsum was selected as the process aid of choice.

Fluid fine tailings can also be treated with a flocculant, coagulant, or both, and thickened in a thickener or by in-line treatment, followed by deposition into a disposal area (often referred to as “accelerated dewatering” or “ADW”). In both these instances, the coagulant of choice is gypsum, which aids in the dewatering of the FFT.

The cost of gypsum, especially in the amounts necessary to treat decades of produced fluid fine tailings, can be high. Thus, the present Applicant explored other options to reduce the costs associated with the use of gypsum in oil sand tailings treatment.

### SUMMARY OF THE INVENTION

The present Applicant's oil sand operation includes an emissions reduction plant where quick lime (calcium oxide) is used to reduce sulfur dioxide emissions that are produced when bitumen is upgraded into sweet synthetic crude oil. This process is known as a dry flue-gas desulfurization (FGD) process, which process produces a dry product referred to herein as flue-gas desulfurization solids (FGD solids, also referred to as FGDS). The FGD solids produced from this process are primarily composed of insoluble calcium sulfite hemihydrate and calcium hydroxide (slaked lime), with smaller proportions of petroleum coke, calcium carbonate (limestone) and gypsum (calcium sulfate dihydrate). As used herein, “FGD solids” or “FGDS” refers to the dry product produced when using quick lime (calcium oxide) to capture SO₂, namely, dry solids comprising calcium sulfite hemihydrate, calcium sulfate dihydrate (gypsum), calcium carbonate, calcium oxide, calcium hydroxide (slaked lime) and petroleum coke. It is understood that, with other flue-gas desulfurization processes, or with different modes of operation of the current process, different products may be produced.

The present applicant produces about 144,000 tonnes of FGD solids annually. Due to the slaked lime content, which could produce an alkaline leachate, a Class II landfill is required to dispose of FGD solids, and on-site landfills are not necessarily consistent with long-term mine closure planning activities. While it is known to treat tailings with both gypsum and lime, it was not known whether the FGD solids could be used as a tailings process aid, especially in view of it specific composition and commercial scale variability, e.g., large and potentially variable amounts of calcium sulfite hemihydrate, coke and limestone (inerts). On average, FGD solids are comprised of about 30% slaked lime, 6% gypsum and 64% inerts. Further, it was unknown whether the released water chemistry, in particular, when using the CT process as a tailings treatment option, would be acceptable.

It was surprisingly discovered that not only were FGD solids a suitable substitute for much more expensive coagulants such as gypsum, lime, or alum, but the inert components appear to improve treated tailings deposit performance.

Using FGD solids as a coagulant may have one or more of the following advantages:
Acceptable performance as a tailings process aid;
Acceptable release water chemistry, in particular, when used in CT process;
Reduce/eliminate gypsum purchasing costs;
Mitigate or eliminate the need to operate and maintain a Class II landfill, currently required for FGD solids disposal.

Thus, in one aspect, a process for improving the dewatering characteristic of tailings is provided comprising adding flue-gas desulfurization solids (FGD solids), produced when using calcium oxide to remove sulfur dioxide from emissions, to the tailings. In one embodiment, the tailings are tailings produced during bitumen extraction from oil sand having a solids content in the range of about 10 wt % to about 45 wt %. In one embodiment, the tailings are fluid fine tailings or mature fine tailings. In one embodiment, the FGD solids (dry solids) are comprised of calcium sulfite hemihydrate, calcium sulfate dihydrate, calcium carbonate, calcium oxide, calcium hydroxide and petroleum coke.

In one embodiment, the process further comprises adding a flocculant to the tailings either before, during, or after addition of the FGD solids. In one embodiment, the flocculant is an anionic, nonionic, cationic or amphoteric polymer. In one embodiment, the tailings are dewatered by centrifugation, by gravity in tailings deposits, or in a thickener.

In one embodiment, sand is added to the tailings at a sand to fines ratio of about 3.5:1 to about 5:1 prior to the addition of the FGD solids to form composite tailings (CT) or non-segregating tailings (NST).

In one embodiment, FGD solids are added at a dosage of about 1000 g/tonne of tailings solids to about 9000 g/tonne of tailings solids. In one embodiment FOD solids are added at a dosage of about 1500 g/tonne of tailings solids to about 4500 g/tonne of tailings solids.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a graph showing the settling rates of four composite tailings (CT) columns treated with four different concentrations of FGD solids.

FIG. 2 is a graph showing the settling rates of four CT samples treated with (1) 800 g/t slaked lime (CaO); (2) 800 g/t hydrated lime (Ca(OH)₂); (3) FGD solids dosage equal to the dosage of CaO; and (4) FGD solids dosage equal to the dosage of Ca(OH)₂.

FIG. 3 is a bar graph showing the settled volume (ml) versus time (settling rate) for a flocculated (with A3338) 3 wt % mature fine tailings suspension pretreated with either 1500 g/t gypsum or 3000 g/t FGD solids (Plant 29 Solids).

FIG. 4 is a schematic of a process for treating tailings where FGD solids can be used.

### DETAILED DESCRIPTION OF THE PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The present invention relates generally to a process for improving the dewatering characteristic of tailings comprising adding flue-gas desulfurization solids (FGD solids), produced when using calcium oxide to remove sulfur dioxide from emissions, to the tailings. For commercial scale consideration, the FGD solids were assessed to determine if the solids had suitable and consistent chemistry to perform as a tailings process aid. Further, the effectiveness of FGD solids in three tailings treatment processes, the composite tailings (CT) process, accelerated dewatering and centrifugation, were tested.

As used herein, the term “tailings” means any tailings produced during a mining operation and, in particular, tailings derived from oil sands extraction operations that contain a fines fraction. The term is meant to include fluid fine tailings (FFT) from oil sands tailings ponds and fine tailings from ongoing oil sands extraction operations (for example, flotation tailings, thickener underflow, PSV underflow or froth treatment tailings) which may or may not bypass a tailings pond. In one embodiment, the tailings are primarily FFT, including mature fine tailings (MFT), obtained from oil sands tailings ponds given the significant quantities of such material to reclaim. However, it should be understood that the fine tailings treated according to the process of the present invention are not necessarily obtained from a tailings pond, and may also be obtained from ongoing oil sands extraction operations.

As used herein, “g/tonne” or “g/t” means an amount of FGD solids or flocculant or other process aid, in grams, added per tonne of tailings solids.

As used herein, the term “flocculation” refers to a process of contact and adhesion whereby the particles of a dispersion form larger-size clusters in the form of flocs or aggregates. As used herein, the term “flocculant” refers to a reagent which promotes flocculation by bridging colloids and other suspended particles in liquids to aggregate, forming a floc. Flocculants useful in the present invention are generally anionic polymers, which may be naturally occurring or synthetic, having relatively high molecular weights. In one embodiment, the dosage of the anionic polymeric flocculant ranges from between about 0 to about 1500 grams per tonne of solids in the tailings.

Suitable natural polymeric flocculants may be polysaccharides such as guar gum, gelatin, alginates, chitosan, and isinglass. Suitable synthetic polymeric flocculants include, but are not limited to, polyacrylamides, for example, a high molecular weight, long-chain modified polyacrylamide (PAM). PAM is a polymer (—CH₂CHCONH₂—)ₙ formed from acrylamide subunits with the following structure:

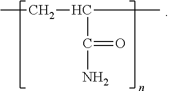

It can be synthesized as a simple linear-chain structure or cross-linked, typically using N,N′-methylenebisacrylamide to form a branched structure. Even though such compounds are often called “polyacrylamide,” many are copolymers of acrylamide and one or more other chemical species, such as an acrylic acid or a salt thereof. The “modified” polymer is thus conferred with a particular ionic character, i.e., changing the anionicity of the PAM. Preferably, the polyacrylamide anionic flocculants are characterized by molecular weights ranging between about 10 to about 24 million, and medium charge density (about 25-30% anionicity). It will be appreciated by those skilled in the art that various modifications (e.g., branched or straight chain modifications, charge density, molecular weight, dosage) to the flocculant may be contemplated.

### EXAMPLE 1

To assess variability in product quality, a monitoring program was initiated to evaluate the FGD solids produced over time. Typical component concentrations of FGD solids are shown in Table 1, below.

TABLE 1
Chemical Composition of FGD Solids

| Chemical | | Common | Average |
|---|---|---|---|
| Formula | Name | Name | wt. % |
| CaSO₃ · ½H₂O | Calcium sulfite | — | 44 ± 8 |
| | hemihydrate | | |
| CaSO₄ · 2H₂O | Calcium sulfate | Gypsum | 6 ± 1 |
| | dihydrate | | |
| CaCO₃ | Calcium carbonate | Limestone | 9 ± 3 |
| | | (calcite) | |
| CaO | Calcium oxide | Quicklime | <1 |
| Ca(OH)₂ | Calcium hydroxide | Slaked lime/ | 30 ± 5 |
| | | hydrated lime | |
| Inerts | Coke | — | 10 ± 2 |
| H2O | Water | — | 1 ± 0.5 |

To provide further information on the material composition, and assess water soluble components, soluble ion tests were completed for a series of FGD solid samples collected weekly during a one year period of time. The test involved preparing a 1000 part per million (ppm) mixture by adding 1 g of FGD solids into 1 Liter of deionized water and measuring the resulting ions in solution. The results of the analyses are summarized in Table 2 below.

TABLE 2
Water Solubles Properties Averaged Over a One-Year Period

| | | Con- | | Alkalinity | |
|---|---|---|---|---|---|
| | | ductivity | SO₄ | as CaCO₃ | Ca |
| | pH | (μS/cm) | (mg/L) | (mg/L) | (mg/L) |
| Average | 11.8 | 1951 | 34 | 446 | 206 |
| Std | 0.18 | 413 | 5 | 109 | 45 |
| Deviation | | | | | |
| % | 2% | 21% | 15% | 24% | 22% |
| Uncertainty | | | | | |

The most dominant active ingredient in the FGD solids in terms of tailings process aid is the slaked or hydrated lime (Ca(OH)₂), augmented by the smaller but still significant gypsum content. The availability of gypsum and the presence of the fine grained inert components may explain why the FGD solids are more effective in tailings treatment than commercially available slaked lime. Table 2 shows that the soluble ion variation in FGD solids samples over the one year period compares to the established variation in FGD solids composition from the more detailed solids composition analysis. The variation over time in the lime content of about 20% is acceptable for a tailings process aid. The lower values can be used to define minimum acceptable dosages to account for both process-aid quality and process variations.

It was also discovered that FGD solids are fine grained relative to commercially available gypsum, for example, agricultural grade gypsum, and this significantly improves the rate at which the FGD solids can go into solution and effectively interact with the tailings, e.g., MFT, minerals. In particular, it was discovered that greater than 90% of the FGD solids are less than 44 μm, where only around 66% of agricultural grade gypsum is less than 44 μm. Thus, the dissolution time for FGD solids is shorter and the FGD solids has better material handling when preparing slurries. Table 3 below summarizes the particle size distribution (PSD) of high purity agricultural grade gypsum versus FGD solids.

TABLE 3
Particle Size Distribution (PSD)

| | Gypsum | Gypsum | FGD | FGD Solids |
|---|---|---|---|---|
| Size | % | % greater | Solids | % greater |
| (μm) | passing | than | % passing | than |
| 360 | — | — | — | — |
| 180 | — | — | — | — |
| 150 | 89.2 | 10.8 | — | — |
| 125 | — | — | — | — |
| 100 | — | — | 100 | 0 |
| 88 | — | — | — | — |
| 74 | 76.7 | 23.3 | — | — |
| 62 | — | — | — | — |
| 44 | 65.7 | 34.3 | 90 | 10 |
| 0 | 0 | 100 | 0 | 100 |

### EXAMPLE 2

A test program was undertaken to assess the suitability of FGD solids as a tailings process aid in the composite tailings (CT) process. Four laboratory scale columns (2 L) were used to contain prepared CT mixtures with a nominal sand to fines ratio (SFR) of about 3.5 and a solids content of about 55 wt.%. Table 4 below shows the actual composition of the prepared CT mixtures and the associated FGD solid dosages. All four columns contained FGD solids dosages considerably larger than what is currently used in the Applicant's commercial CT process with gypsum (˜1200g/m³ of CT). The columns were monitored for a period of 11 days to assess the initial water release and to determine the degree of any segregation.

TABLE 4

| | Solids | Mass | Mass of | Dosage g | Dosage |
|---|---|---|---|---|---|
| | (wt. | CT | FGD Solids | FGD/m³ | g FGD/ |
| Column | %) | (kg) | added (g) | CT | tonne CT |
| Test 1 | 55.99 | 2 | 4 | 3070 | 2000 |
| Test 2 | 57.86 | 2 | 8 | 6253 | 4000 |
| Test 3 | 54.03 | 2.2 | 5.2 | 3562 | 2364 |
| Test 4 | 51.34 | 2.2 | 10.4 | 6948 | 4727 |

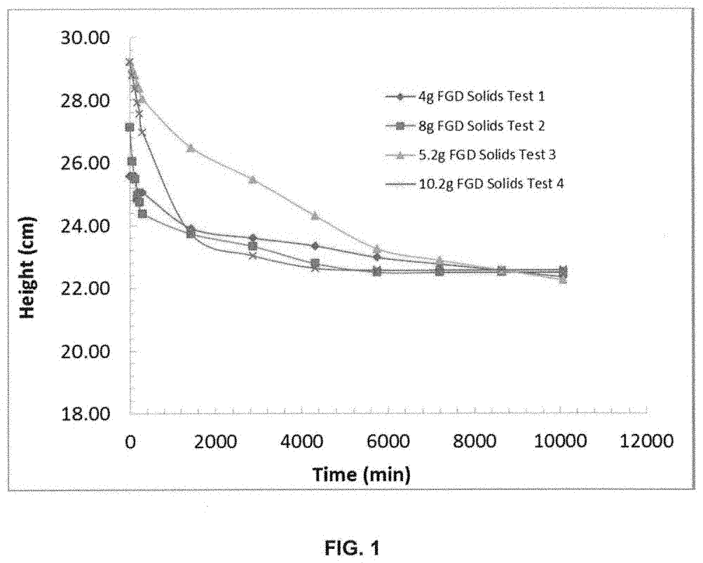

FIG. 1 shows the settling rate for the four prepared CT recipes described in Table 4. It can be seen that the initial settling rate is very rapid, followed by a slower settling and consolidation period. After a time period of about 4 days, settlements were similar for all 4 tests. Samples were taken from the top, middle and bottom of the columns to determine whether segregation had occurred. Segregation would be indicated by a significantly lower sand content in the upper layers, and a higher sand content in the lower layers, indicating separation or segregation of the fines from the sand matrix. It was found that the sand to fines ratio in the top, middle and bottom layers were essentially the same, indicating that little or no segregation had occurred.

The release water was also tested for quality and compared to typical recycle water (RCW). The results are shown in Table 5 below. The CT release water quality was acceptable for the FGD solid doses assessed. It did not result in material concentration increases in sodium, chloride, magnesium, or sulfate. In addition, the pH changes were consistent with operational ranges in RCW which typically varies between 8 (tailings ponds) and 11 (extraction).

TABLE 5
Chemistry of CT Release Water Compared to Typical
Recycled Water (RCW)

| FGD | | | | | | | | | | Ion |
|---|---|---|---|---|---|---|---|---|---|---|
| Dose | Release Water Chemistry | | | | | | | | | Bal- |
| (g/m3) | Ca | K | Mg | Na | Cl | SO₄ | CO₃ | HCO₃ | pH | ance |
| 3070 (Test 1) | 52 | 11 | 2 | 647 | 374 | 853 | 1 | 71 | 8.4 | 1.06 |
| 6253 (Test 2) | 15 | 12 | 0 | 725 | 359 | 572 | 160 | 18 | 11.3 | 1.18 |
| 3562 (Test 3) | 28 | 10 | 1 | 667 | 367 | 732 | 1 | 88 | 7.6 | 1.13 |
| 6948 (Test 4) | 21 | 14 | 0 | 687 | 375 | 506 | 216 | 5 | 11.9 | 1.1 |
| RCW | 35 | 14 | 16 | 610 | 340 | 527 | 2 | 270 | 8.1 | 1.19 |

All values in mg/L except pH

### EXAMPLE 3

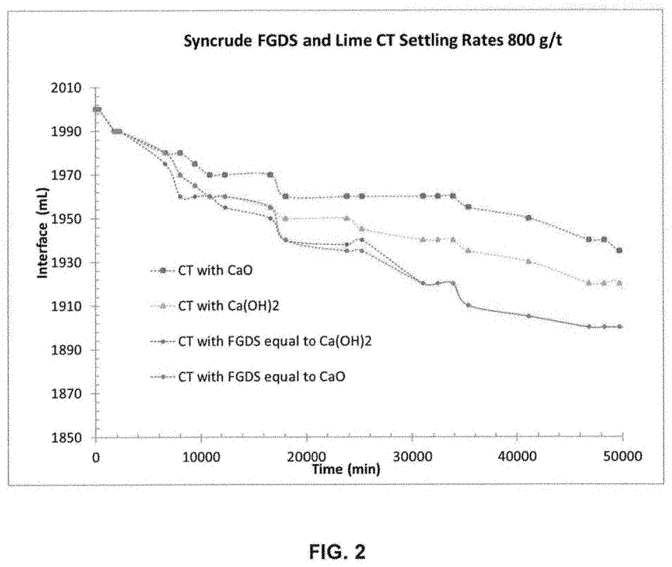

Similar to Example 2, four laboratory scale columns (2 L) were used to contain prepared CT mixtures with a nominal sand to fines ratio (SFR) of about 3.5 and a solids content of about 55 wt.%. The CT preparations were treated with (1) 800 g/t slaked lime (CaO); (2) 800 g/t hydrated lime (Ca(OH)₂); (3) FGD solids dosage equal to the dosage of CaO; and (4) FGD solids dosage equal to the dosage of Ca(OH)₂. FIG. 2 shows the various CT samples settling rates as indicated by the decrease in the interface (m1) of the CT in the 2 L cylinders per time (min). It can be seen from FIG. 2 that the settling rate for CT made with FGD solids is superior to that with an equivalent CAO or Ca(OH)₂ coagulant addition.

As previously mentioned, maintaining a non-segregating mixture is critical to the performance of the CT deposit as it settles. Table 6, below, shows the analysis of the fines (−44 micron) percentage at the top, middle, and bottom of the settling columns. If the CT sample is not segregating, the fines percentage will be the same top to bottom. If the coagulant dosage is inadequate, the coarse sand will settle out, leaving a higher fines percentage in the upper layer of the settling test column. Table 6 shows that, not only is the settling rate for CT superior with FGD solids, the FGD solids treated samples do not segregate.

TABLE 6
Analysis of the settled CT columns made with
CaO, Ca(OH)₂, and the equivalent dosages of FGDS.

| Location in | | nominal | −44 | |
|---|---|---|---|---|
| Settling | | dosage | micron | |
| Column | Coagulant | gm/m³ | percentage | Comment |
| Top Fraction | CaO | 800 | 39.7 | some |
| | | | | segregation |
| Middle Fraction | CaO | 800 | 37.2 | some |
| | | | | segregation |
| Bottom Fraction | CaO | 800 | 33.2 | some |
| | | | | segregation |
| Middle Fraction | Ca(OH)2 | 800 | 51.3 | significant |
| | | | | segregation |
| Bottom Fraction | Ca(OH)2 | 800 | 43.5 | significant |
| | | | | segregation |
| Top Fraction | FGDS | 800 | 47.7 | some |
| | Ca(OH)₂ | | | |
| | eqv | | | segregation |
| Middle Fraction | FGDS | 800 | 33.2 | some |
| | Ca(OH)₂ | | | |
| | eqv | | | segregation |
| Bottom Fraction | FGDS | 800 | 37.8 | some |
| | Ca(OH)₂ | | | |
| | eqv | | | segregation |
| Top Fraction | FGDS | 800 | 33.3 | no |
| | CaOeqv | | | segregation |
| Middle Fraction | FGDS | 800 | 35.5 | no |
| | CaO eqv | | | segregation |
| Bottom Fraction | FGDS | 800 | 35.1 | no |
| | CaO eqv | | | segregation |

### EXAMPLE 4

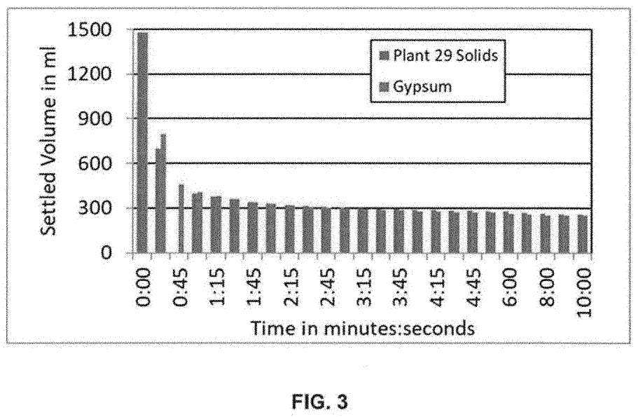

In the Applicant's current Full Scale FFT centrifuge plant, gypsum is used to treat the clays present in tailings (e.g., FFT or MFT) prior to flocculant addition. It is critical to determine whether pre-treatment with FGD solids will adversely affect the flocculant performance. A sensitive way to test any effect of FGD solids (versus gypsum) is to evaluate flocculant performance in dilute suspensions. The use of a dilute suspension serves to increase the performance range compared to monitoring the effect on undiluted MFT. FIG. 3 is a bar graph showing the settling rates (settled volume in ml versus time in minute:seconds) for a 3 weight per cent MFT suspension treated with 1500g/tonne of fines gypsum (right hand bars) and 3000 g/tonne of fines FGD solids (left hand bars). The flocculant used in each case was 500 g/tonne of fines A3338, an anionic, high molecular weight polyacrylamide that is currently used in the Applicant's centrifuge plant. It can be seen that the FGD solids and gypsum pre-treatments result in essentially the same settling rates, indicating that there would be no impact on the flocculant (polymer) effectiveness when substituting FGD solids for gypsum.

To test the strength development in the centrifuge cake, several modifications to the standard viscosity and yield point test procedure were made. For instance, both the peak yield and the yield stress after 60 seconds were chosen. Four test conditions were used: MFT samples pretreated with either nothing, 3000 g/tonne of fines FGD solids, 9000 g/tonne of fines FGD solids or 1500 g/tonne of fines gypsum, followed by treatment with 400 g/tonne of fines flocculant A3338. The flocculated MFT samples were then centrifuged under standard conditions (1500 rpm for 5 minutes). For both the flocculated and centrifuged samples, the peak and remoulded yield points were determined. Table 7 summarizes these results for flocculated MFT (the average of four tests each) and Table 8 summarizes the results for the flocculated and centrifuged MFT (the average of four tests each).

TABLE 7
Flocculated MFT

| | Peak | Peak | | Remoulded |
|---|---|---|---|---|
| | Yield | Yield Std | Remoulded | Yield Std |
| Sample ID | (Pa) | Dev (Pa) | Yield (Pa) | Dev (Pa) |
| MFT no | 8.4 | 1.1 | 7.5 | 0.8 |
| additive | | | | |
| Gypsum | 12.8 | 1.5 | 11.5 | 1.3 |
| 1500 g/t | | | | |
| FGD Solids | 14.5 | 2.7 | 13.5 | 2.5 |
| 3000 g/t | | | | |
| FGD Solids | 23.8 | 4.7 | 21.8 | 4.3 |
| 9000 g/t | | | | |

TABLE 8
Flocculated and Centrifuged MFT

| | Peak | Peak | | Remoulded |
|---|---|---|---|---|
| | Yield | Yield Std | Remoulded | Yield Std |
| Sample ID | (Pa) | Dev (Pa) | Yield (Pa) | Dev (Pa) |
| MFT no | 453 | 67 | 380 | 54 |
| additive | | | | |
| Gypsum | 481 | 39 | 416 | 30 |
| 1500 g/t | | | | |
| FGD Solids | 669 | 69 | 579 | 59 |
| 3000 g/t | | | | |
| FGD Solids | 782 | 36 | 691 | 34 |
| 9000 g/t | | | | |

The data shown in Tables 7 and 8 suggests that less than two times the FGD solids dosage would be as effective as gypsum in increasing the strength of the centrifuge cake and, therefore, the throughput.

Thus, FGD solids can substitute for gypsum in the FFT centrifuge process with an increase in dosage consistent with that determined for substitution in the CT process. In the CT process, gypsum or FGD solids are the only additive. For centrifuge applications, flocculation is a critical part of the process and it has been demonstrated that the FGD solids does not affect flocculant (polymer) performance. The FGD solids dosage relative to gypsum determined from the yield point increases for both treated MFT and the centrifuge cake but is somewhat less than that determined for CT substitution, however, consistent with the three times dosage determined from the CT studies. In addition, a two or three times dosage increase is well within the range of the gypsum dosing system at the FFT centrifuge Full Scale plant.

The yield point comparisons suggest that a dosage of FGD solids at 3000 g/tonne of tailings solids would produce similar results as 1500 g/tonne of gypsum. This means approximately 1500 to 4500 g/tonne of FGD solids compared to the target gypsum dosage of 500 to 1500 g/tonne.

Without being bound to theory, it is believed that the addition of FGD solids results in a combination of yield point and viscosity improvement due to the increase in pH from the residual lime and lesser amounts of gypsum, as well as a slight strength increase due to the inert and fine powdered coke and calcium sulfite. Cation exchange with Ca²⁺ from the lime may also be playing a role in this case as well. The minor component of gypsum in the FGD solids may also contribute to the effectiveness to a small extent.

### EXAMPLE 5

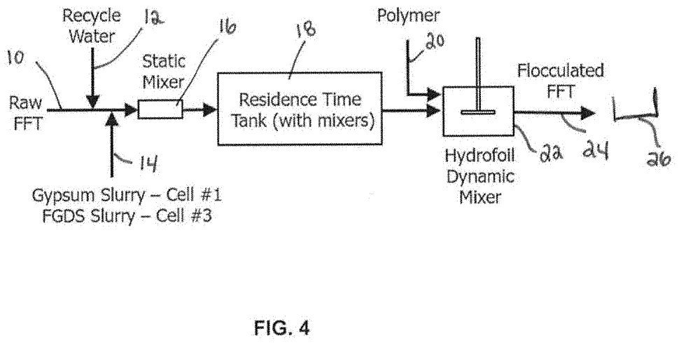

As previously mentioned, accelerated dewatering (ADW) is a tailings treatment option that uses pre-treatment of tailings, such as fluid fine tailings, with a coagulant such as gypsum (i.e., multivalent cations) followed by treatment with a flocculant such as a polyacrylamide anionic flocculant. The ADW process uses the same process additives as the centrifuge process, with a coagulant pretreatment followed by polymeric flocculant addition. A pilot study on accelerated dewatering was done using cells as deposition sites to test the use of FGD solids as a substitute for gypsum. FIG. 4 is a schematic of the process used to prepare treated tailings for deposition into cells.

As shown in FIG. 4, raw fluid fine tailings (FFT) 10 having a solids content of about 35 wt % were first diluted with recycle water 12 to a solids content of about 28 wt %, followed by the addition of coagulant 14, which was either about 1300 g/tonne gypsum (cell #1) or about 3500 g/tonne FGD solids (FGDS) (cell #3). The tailings/coagulant was then mixed in an in-line static mixer 16 and the mixture was allowed to further mix in a residence time tank 18 having mixers therein. The mixture was then treated with about 1100 g/torme flocculant (polymer) 20 and further mixed in a hydrofoil dynamic mixer 22. The flocculated FFT 24 was then deposited into cells 26.

As mentioned, cell #1 contained FFT that had been pre-treated with gypsum and cell #3 contained FFT that had been pre-treated with FGDS. After two months, the treated FFT in cell #1 had a solids content of about 52 wt % solids and cell #3 had a solids content of about 54 wt % solids, which translates to a 4.2% reduction in water volume, showing that FGDS is superior to gypsum when used as a tailings pre-treatment in accelerated dewatering.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

We claim:

1. A process for improving the dewatering characteristic of tailings comprising adding flue-gas desulfurization (FGD) solids, produced when using calcium oxide to remove sulfur dioxide from emissions, to the tailings.

2. The process as claimed in claim 1, further comprising adding a flocculant to the tailings either before, during, or after the addition of FGD solids.

3. The process as claimed in claim 2, further comprising subjecting the tailings to centrifugation or gravity settling in a tailings deposit or thickener after the addition of the FGD solids and flocculant.

4. The process as claimed in claim 2, wherein the flocculant is an anionic polymer.

5. The process as claimed in claim 4, wherein the anionic polymer is an anionic polyacrylamide.

6. The process as claimed in claim 1, wherein the tailings are oil sand tailings produced during bitumen extraction from oil sand having a solids content in the range of about 10 wt % to about 45 wt %.

7. The process as claimed in claim 6, wherein the oil sand tailings are thin fine tailings.

8. The process as claimed in claim 6, wherein the oil sand tailings are fluid fine tailings.

9. The process as claimed in claim 6, wherein the oil sand tailings are mature fine tailings.

10. The process as claimed in claim 1, further comprising adding sand to the tailings at a sand to fines ratio of about 3.5:1 to about 5:1 prior to, during, or after the addition of FGD solids to form composite tailings.

11. The process as claimed in claim 1, wherein the FGD solids are added at a dosage of about 1000 to 9000 g/tonne of tailings solids.

12. The process as claimed in claim 1, wherein the FGD solids are added at a dosage of about 1500 to 4500 g/tonne of tailings solids.

13. The process as claimed in claim 1, wherein the FGD solids are comprised of calcium sulfite hemihydrate, calcium sulfate dihydrate, calcium carbonate, calcium oxide, calcium hydroxide and petroleum coke.
